(19) United States
(12) Patent Application Publication
(10) Pub. No.: US 2018/0172195 A1
(43) Pub. Date: Jun. 21, 2018

(54) INTEGRATED MUFFLER AND PULSATION DAMPENER FOR A COMPRESSOR

(71) Applicant: Ingersoll-Rand Company, Davidson, NC (US)

(72) Inventors: Philipp Schulze-Beckinghausen, Oberhausen (DE); Jan Hauser, Dortmund (DE); Michael Beinert, Dortmund (DE); Sven Herlemann, Datteln (DE)

(21) Appl. No.: 15/381,329

(22) Filed: Dec. 16, 2016

(51) Int. Cl. F16L 55/04; F04B 39/00; F04D 29/66

(52) U.S. Cl. CPC F16L 55/041; F04D 29/668; F04B 39/0061

(57) ABSTRACT

An aspect of the present disclosure includes a compressor system operable for compressing a working fluid. An integrated muffler and pressure pulse dampener (IMPPD) is operable for reducing pressure pulsations and attenuating noise in the working fluid. The IMPPD system includes an elongate axial passageway bounded by an outer wall having a plurality of apertures extending therethrough. A first portion of the working fluid enters through the central elongate section and a second portion of the working fluid passes through the pertures. The first and second portions of working fluid merge together downstream of the IMPPD inlet and cause a dampening of pressure pulsations propagating within the working fluid.

### TECHNICAL FIELD

The present application generally relates to industrial air compressor systems and more particularly, but not exclusively, to a compressor system having an integrated muffler and pressure pulsation dampener.

### BACKGROUND

Industrial compressor systems are configured to produce large volumes of pressurized fluid such as air or the like. Pressure pulsations in the working fluid may be perturbated upstream or downstream of a fluid compressor. Some pressure pulsations having relatively large amplitudes may cause damage to piping or other components and may generate relatively extreme noise levels. Some existing systems have various shortcomings, drawbacks, and disadvantages relative to certain applications. Accordingly, there remains a need for further contributions in this area of technology.

### SUMMARY

One embodiment of the present application is a compressor system with an integrated muffler and pressure pulsation dampener. Other embodiments include apparatuses, systems, devices, hardware, methods, and combinations for an integrated muffler pressure pulsation dampener. Further embodiments, forms, features, aspects, benefits, and advantages of the present application shall become apparent from the description and figures provided herewith.

### BRIEF DESCRIPTION OF THE FIGURES

FIG. 1 is a perspective view of a compressor system according to one embodiment of the present disclosure;

FIG. 2 is a schematic view of a portion of the compressor system of FIG. 1 with an integrated muffler and pressure pulsation dampener according to an embodiment of the present disclosure;

FIG. 3 is a perspective view of an exemplary integrated muffler and pressure pulsation dampener;

FIG. 4 is a perspective view of one embodiment of the exemplary integrated muffler and pressure pulsation dampener installed in a compressor housing; and

FIG. 5 is a perspective view of another embodiment of the exemplary integrated muffler and pressure pulsation dampener installed in a compressor housing.

### DETAILED DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Industrial compressor systems are configured to provide large quantities of compressed fluids at a desired temperature, pressure and mass flow rate. Some compressor systems include fluid to fluid heat exchangers to control the temperature of a compressed fluid at various stages within the system. The term “fluid” should be understood to include any gas or liquid medium used in the compressor system as disclosed herein. In one aspect the fluid can include mixtures of air and oil and can be separated into separate constituents in a separating tank. In one aspect, the present disclosure is directed to suppressing pressure pulsations and reducing noise in a working fluid that includes compressed air; however it should be understood that when the term “air” is used in the specification or claims that other working fluids are included under a broad definition of compressible fluids. Also, when the term “oil” is used in the specification or claims, it should be understood that any lubrication fluid whether carbon based or synthetic in nature is contemplated herein.

The present application is generally directed to suppressing, reducing, and/or dampening pressure pulsations in a working fluid as generated by a compressor, blower or other similar types of devices. An integrated muffler and pressure pulsation dampening device (hereinafter “IMPPD”) described herein may be used to suppress pressure pulsations and reduce noise levels output by the apparatus.

At an inlet and/or discharge of a compressor, there are pressure pulsations generated by unsteady gas dynamic flows. The gas dynamic becomes the origin for pressure pulsations that propagates as an aerodynamic wave that travels at the convective speed of the gas. Generally, one source of noise in the near-field is due to gas dynamic disturbances originating from the opening and closing of the discharge port at the outlet of the compressor. The generation of pressure pulsations near the discharge of the compressor may be described as an aerodynamic phenomenon. Downstream from the compressor discharge port, the aerodynamic instabilities become smaller while the pressure pulsation disturbances evolve into an acoustic field. The acoustic field propagates at the speed of sound and is one source of noise generated by the compressor. In certain configurations, pressure pulsations in the working fluid may propagate upstream of the compressor system as well as downstream.

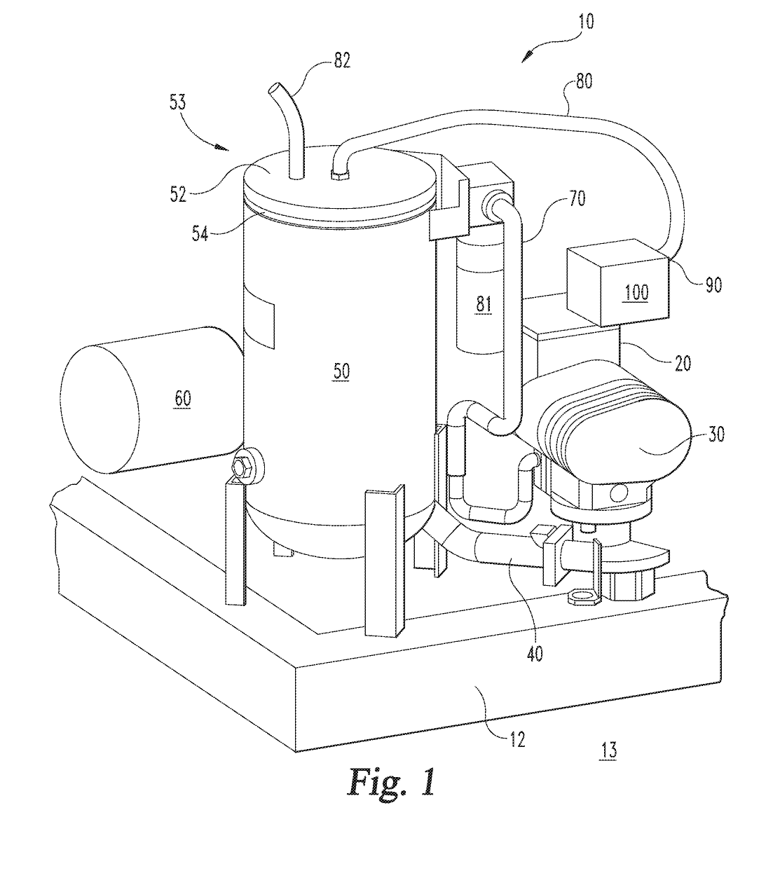

Referring now to FIG. 1, an exemplary compressor system 10 is shown therein. The compressor system 10 includes a primary motive source 20 such as an electric motor, an internal combustion engine or a fluid-driven turbine and the like. The compressor system 10 can include a compressor 30 that may include multi-stage compression. The compressor 30 can include a screw, centrifugal, axial and/or positive displacement compression means. The primary motive source 20 is operable for driving the compressor 30 via a drive shaft (not shown) to compress gaseous working fluids such as air and oil vapor or the like.

A structural base 12 is configured to support at least portions of the compressor system 10 on a support surface 13 such as a floor or ground. Portions of the compressed working fluid discharged from the compressor 30 can be transported through one or more conduits 40 to a sump or separator tank 50 for separating fluid constituents such as air and oil or the like. One or more coolers 60 can be operably coupled with the system 10 for cooling working fluids to a desired temperature. The one or more coolers 60 can cool working fluids such as compressed air or oil to a desired temperature. The compressor system 10 can also include a controller 100 operable for controlling the primary motive power source 20 and various valving and fluid control mechanisms (not shown) between the compressor 30 and intercoolers 60 such as a blow down valve 90.

The separator tank 50 can include a lid 52 positioned proximate a top portion 53 thereof. A seal 54 can be positioned between the lid 52 and separator tank 50 so as to provide a fluid-tight connection between the lid 52 and the separator tank 50. Various mechanical means such as threaded fasteners (not shown) or the like can be utilized to secure the lid 52 to the separator tank 50. A blow down conduit 80 can extend from the separator tank 50 to the blow down valve 90. The blow down valve 90 is operable for reducing pressure in the separator tank 50 when the compressor 30 is unloaded and not supplying compressed air to an end load. An air supply conduit 82 can be operably coupled to the separator tank so as to deliver compressed air to a separate holding tank (not shown) or to an end load for industrial uses as would be known to those skilled in the art. An oil supply conduit 70 can extend from the separator tank 50 to the compressor 30 to supply oil that has been separated from the working fluid in the separator tank 50 to the compressor 30. One or more filters 81 can be used in certain embodiments to filter particles from the oil and/or separate contaminates such as water or the like from working fluids in the compressor system 10.

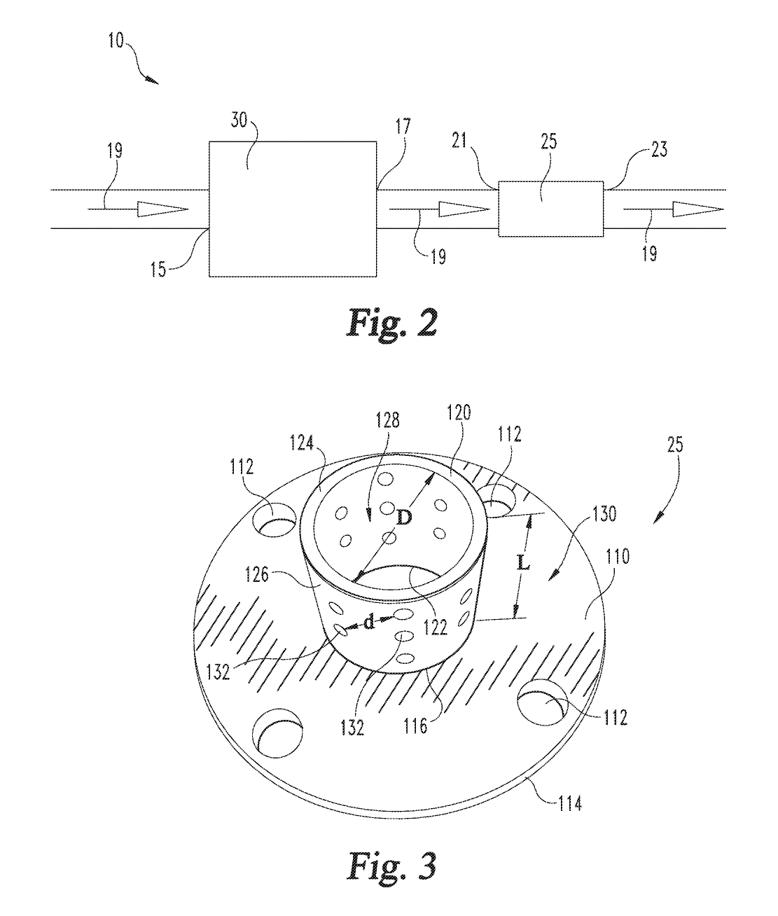

Referring now to FIG. 2, a schematic view of compressor system 10 is depicted in accordance with an embodiment of the present specification. The compressor system 10 may include a compressor or blower 30 having an inlet 15 and an outlet 17 at the discharge side. A working fluid represented by arrow 19 is directed into the compressor 30 via the inlet 15 and exits the compressor via the outlet 17. In one form the compressor outlet 17 is in fluid communication with an inlet 21 of an integrated muffler and pressure pulsation dampener (IMPPD) 25. As the working fluid flows through the IMPPD 25, pressure waves or pulsations are dampened such that noise is decreased or muffled and impulse forces of the pulsation loads may also be reduced. It should be noted that in alternate embodiments an IMPPD 25 may be positioned upstream of the compressor 30 in lieu of or in addition to an IMPPD 25 being positioned downstream of the compressor 30.

In one form, the compressor 30 can be a screw compressor. In refined forms, the compressor 30 can be an oil-free screw compressor. In yet other forms, the compressor 30 may be a piston compressor, a lobed compressor, scroll compressor, or other types of positive displacement compressors. In still other forms, compressor 30 may be a centrifugal compressor, a vane compressor, a blower, a fan, or a fluid pump.

In one embodiment, Compressor 30 pressurizes a working fluid 19, such as air, and discharges the pressurized fluid at the outlet 17 for use by the downstream components. The pressurized working fluid 19 may travel directly or indirectly to the inlet 21 of an IMPPD 25. The working fluid 19 then exits the IMPPD 25 at its outlet 23 with smaller amplitude of pressure pulsations than were present in the fluid 19 upon entering at the inlet 21.

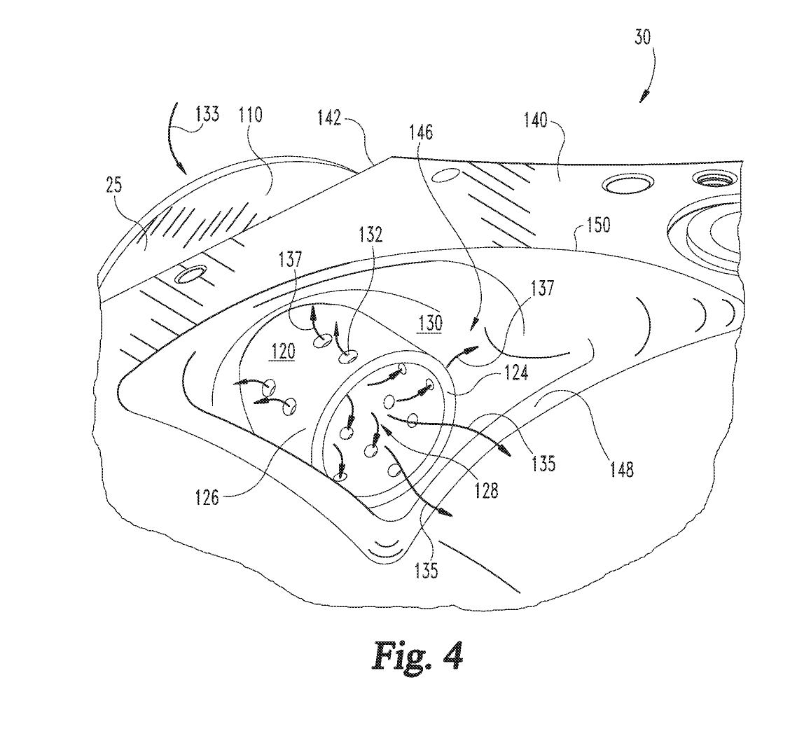

Referring now to FIG. 3 an exemplary IMPPD 25 is illustrated in a perspective view. The IMPPD 25 can include a mounting plate 110 for facilitating a connection to a portion of the compressor system. The mounting plate 110 can include mounting apertures 112 for threaded fasteners or the like to extend therethrough and mechanically connect with a mounting region (not shown) of the compressor 30. The mounting plate 110 can include a perimeter 114 that can be substantially circular in configuration as illustrated in the exemplary embodiment. In other forms the perimeter 114 of the mounting plate 110 can be of other shapes with variable sizing as one skilled in the art should readily understand. For example, the perimeter 114 could be square, rectangular, ovalized or other geometric configurations to correspond to a predefined connection region of the compressor 30. The mounting plate 110 includes a hub portion 116 positioned radially inward from the perimeter 114. In one form the hub portion 116 may be centered relative to the mounting plate 110. In other forms the hub portion 116 may be positioned eccentrically or off-center relative to the location of the mounting plate 110. The hub portion is defined by an axial passageway 120 extending therefrom. In some forms, two or more axial passageways 120 may be formed in parallel or at oblique angles relative to one another. In one form the axial passageway 120 can be defined by an elongate substantially circular tube; however, other geometric forms are also contemplated herein. The axial passageway 120 can include an effective cross-sectional flow area defined by diameter D extending at a length L along an axial direction to define a central flow region 128. The cross-sectional flow area of the axial passageway 120 need not be defined by a particular cross-sectional shape. For example when the term “tube” is used herein it need not be circular but can be square or other shapes. The effective flow area or diameter D and the length L of the axial passageway 120 can be varied or tuned to maximize noise attenuation and/or reduce the magnitude of pressure pulsations at a particular operating condition of the compressor system 10. In one form, the axial passageway 120 can include an inlet 122 wherein flow of the working fluid enters and an outlet 124 wherein the flow of the working fluid exits from the central flow region 128 of IMPPD 25 as shown in the embodiment illustrated in FIG. 4. In other forms, the inlet and outlet are reversed with respect to the axial passageway 120 (i.e. flow enters inlet 124 and exits through outlet 122). This will be described in more detail below. An outer wall 126 of the axial passageway 120 defines the outer boundary of the central flow region 128. An external flow region 130 is formed between the outer wall 126 of the axial passageway 120 and the perimeter 114 of the mounting plate 110. In some forms the effective or cross-sectional flow area of the central flow region 128 and the external flow region 130 can vary along the axial length L of the IMPPD 25.

A plurality of through apertures 132 are formed through the outer wall 126 of the axial passageway 120 so as to provide a plurality of pathways for working fluid to move from the central flow region 128 to the external flow region 130 in certain embodiments. In other embodiments, a portion of the working fluid moves through the apertures 132 from the external flow region 130 to the central flow region 128 and mixes with another portion of working fluid therein. In operation the working fluid can enter the central flow region 128 through the inlet 122. A first portion of the working fluid flows entirely through the central flow region 128 and a second portion of working fluid is diverted or bled through the plurality of through apertures 132 and transported to the external flow region 130. The first and second portions of working fluid from the central flow region 128 and the external flow region 130, respectively are then merged back together downstream of the outlet 124 of the IMPPD 25. In other forms the flow of working fluid may be directed through the end 124 and exit through end 122 opposite of the above described embodiment. The pressure disturbances in the working fluid are attenuated as the second portion of the working fluid is separated from the first portion, forced to change direction and speed as it flows through the apertures 132 and then merges back with the first portion downstream of the inlet of the IMPPD 25. Further tuning of the IMPPD 25 for a particular compressor system or operating condition can be accomplished by varying the size, shape, quantity and relative locations of the through apertures 132 associated with the axial passageway 120. For example the distance d between adjacent pairs of through apertures 132 as well as the cross-sectional area of each through aperture 132 can be varied throughout the axial passageway 120.

Referring now to FIG. 4 a portion of a compressor 30 including a compressor housing 140 is shown therein. The compressor housing 140 can include a compressor wall 142 wherein the mounting plate 110 of the IMPPD 25 can be connected thereto by threaded fasteners (not shown) or other mechanical means as would be known to one skilled in the art. The axial passageway 120 in the form of an elongate tube 120 can extend past the compressor wall 142 and into an outlet chamber 146 formed in the compressor housing 140. In other forms chamber 146 may be an inlet chamber 146. The outlet chamber 146 can include one or more walls 148 that form an open space boundary about the elongate tube 120. The flow of working fluid enters into the IMPPD 25 as illustrated by arrow 133 and is transported into the central flow region 128. A first portion of flow illustrated by arrows 135 passes through the central flow region 128 past the outlet 124 and into the chamber 146. A second flow portion illustrated by arrows 137 is diverted through the apertures 132 of the central flow region 128 and is merged with the flow from the first portion 135 entering the external flow region 130 downstream of the outlet 124 of the axial passageway 120. The outlet chamber 146 may have one or more flow passage regions 150 wherein the merged flow of the first 135 and second portions 137 are transported therethrough. In this manner the pressure pulsations of the working fluid can be dampened in a manner such that mechanical vibration and noise generation is reduced using a compact and tunable IMPPD 25 for a predefined system or operating condition.

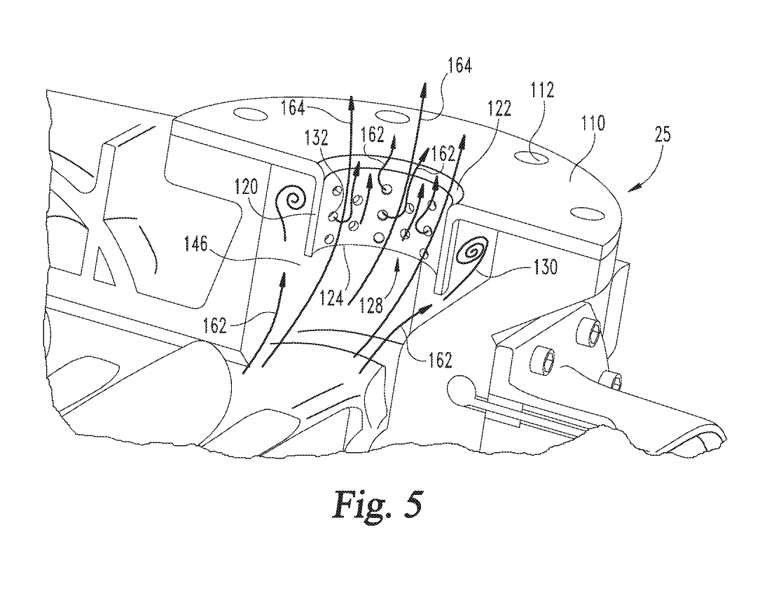

FIG. 5 illustrates an alternate embodiment from that illustrated in FIG. 4. The chamber 146 is positioned upstream of the IMPPD 25 such that compressed working fluid flows into an inlet 124 of the IMPPD 25 and flows through the outlet 122 of the IMPPD 25. A first portion of the compressed working fluid illustrated by arrows 162 enters the external flow region 130 located outward of the axial passageway 120. The first portion 162 can recirculate and reenter the central flow region 128 through apertures 132 as is illustrated by arrows 162. A second portion of the compressed working fluid can enter the central flow region 128 and exit through the axial passageway 120 as illustrated by arrows 164. The first portion of external flow 162 will mix with the flow of the second portion 164 prior to exiting the outlet 122 of the IMPPD 25. In this manner the pressure pulsations of the working fluid can be dampened in such a way that mechanical vibration and noise generation is reduced using a compact and tunable IMPPD 25 for a predefined system or operating condition.

In operation the compressor system is configured to provide compressed air at a desired temperature and pressure to external systems. The compressor systems can be used in any industrial application including, but not limited to automobile manufacturing, textile manufacturing, process industries, refineries, power plants, mining, material handling, etc. In the illustrative example, the compressor system includes a single-stage screw type compressor system; however, the system can operate with other types of compressors and/or with more or less stages of compressors. One or more intercoolers can be fluidly coupled to each compressor stage such that after air is compressed through the first stage the air can be transported through a first intercooler and can be cooled to a desired temperature via a heat transfer mechanism such as conduction and convection in tube-type heat exchangers.

The compressed air can then be transported to additional compressor stages where the air is further compressed and necessarily heated to a higher temperature through a thermodynamic process. The compressed air can then be routed through subsequent intercooler stages coupled to the closed loop water cooling system to cool the air to a desired temperature without substantial loss of pressure. When the air is compressed to a final desired pressure and cooled to a desired temperature, the compressed air is discharged to a final subsystem or end load. In certain embodiments a plurality of IMPPDs can be utilized with each stage of a compressor system. In other embodiments only a single IMPPD is utilized with the system.

In one aspect, the present disclosure includes a system comprising a compressor operable for compressing a working fluid; an inlet chamber in fluid communication upstream of the compressor; an outlet chamber in fluid communication downstream of the compressor; a pressure pulse dampener positioned at least partially in the inlet chamber and/or the outlet chamber, the pressure pulse dampener including: an elongate tube having an axial passageway bounded by an outer wall extending between an inlet and an outlet; and a plurality of apertures extending through the outer wall; and wherein a first portion of the working fluid traverses through the axial passageway and a second portion of the working fluid traverses through the plurality of apertures and mix with the first portion of working fluid-downstream of the inlet.

In refining aspects, the present disclosure includes a circular cross-section; the apertures are evenly spaced from one another; each of the apertures have substantially similar cross-sectional flow areas; the cross-sectional flow area of the tube remains substantially constant from the inlet to the outlet; the pressure pulse dampener includes a mounting plate connected to one of the inlet or outlet ends of the tube; the mounting plate is connectable to a wall associated with one of the inlet and outlet chambers; the mounting plate is connected to an external portion of one of the inlet and outlet chambers and wherein the tube extends into one of the inlet and/or outlet chambers; the first portion and second portion of working fluid mix together downstream of the tube; the first portion and second portion of working fluid mix together within the tube.

In another aspect, the present disclosure includes a pressure pulse dampener system comprising an elongate axial passageway bounded by an outer wall extending between an inlet and an outlet; a plurality of apertures extending through the outer wall; a mounting plate extending radially outward of and connected to one end of the axial passageway; wherein the inlet is configured to receive working fluid and the apertures are configured to transport a portion of the working fluid through the outer wall; and wherein the working fluid transported through the elongate passageway and the portion of the working fluid transported through the outer wall merge back together downstream of the inlet of the axial passageway.

In refining aspects, the present disclosure includes pressure pulse dampener wherein the axial passageway includes a non-circular cross-section wherein a portion of the apertures are unevenly spaced from one another; wherein a portion of the apertures have substantially similar cross-sectional flow areas; wherein the cross-sectional flow area of the axial passageway varies from the inlet to the outlet along the axial direction; wherein the mounting plate is connectable to a wall associated with one of an inlet chamber and an outlet chamber of a compressor; wherein the axial passageway includes two or more separate passageways.

In yet another aspect, the present disclosure includes a pressure pulse dampener system comprising an elongate axial passageway bounded by an outer wall extending between an inlet and an outlet; a plurality of apertures extending through the outer wall; a mounting plate extending radially outward of and connected to one end of the axial passageway; wherein the inlet is configured to receive a first portion of the working fluid and an external region formed about the elongate axial passageway is configured to receive a second portion of working fluid; and wherein the apertures are configured to receive and direct the second portion of working fluid into the axial passageway to mix with the first portion of working fluid prior to exiting through the outlet.

In refining aspects, the present disclosure includes a pressure pulse dampener wherein the axial passageway includes a non-circular cross-section; wherein a portion of the apertures are unevenly spaced from one another; wherein a portion of the apertures have substantially similar cross-sectional flow areas; wherein the cross-sectional flow area of the axial passageway varies from the inlet to the outlet along the axial direction; wherein the mounting plate is connectable to a wall associated with one of an inlet and an outlet chamber of a compressor; wherein the axial passageway includes two or more separate passageways.

In yet another aspect, the present disclosure includes a method for reducing pressure pulsations in a working fluid generated by a compressor comprising transporting the working fluid to a pressure pulsation dampener having a central elongate section with a plurality of through apertures formed in a wall thereof, the elongate section extending between an inlet and an outlet; directing a first portion of the working fluid through the central elongate section; directing a second portion of the working fluid through the apertures; and merging the first portion and second portion of working fluid back together downstream of the inlet.

In refining aspects, the present disclosure includes a method wherein the merging occurs upstream of a compressor; wherein the merging occurs downstream of a compressor; wherein the merging occurs internal to the central elongate section; wherein the merging occurs external to the central elongate section; wherein the pressure pulsation dampener reduces audible noise levels and pressure pulsations in the working fluid.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

What is claimed is:

1. A system comprising:
a compressor operable for compressing a working fluid;
an inlet chamber in fluid communication upstream of the compressor;
an outlet chamber in fluid communication downstream of the compressor;
a pressure pulse dampener positioned at least partially in the inlet chamber and/or the outlet chamber, the pressure pulse dampener including:
an elongate tube having an axial passageway bounded by an outer wall extending between an inlet and an outlet; and
a plurality of apertures extending through the outer wall; and
wherein a first portion of the working fluid traverses through the axial passageway and a second portion of the working fluid traverses through the plurality of apertures and mix with the first portion of working fluid downstream of the inlet.

2. The system of claim 1, wherein the tube includes a circular cross-section.

3. The system of claim 1, wherein the apertures are evenly spaced from one another.

4. The system of claim 1, wherein each of the apertures have substantially similar cross-sectional flow areas.

5. The system of claim 1, wherein the cross-sectional flow area of the tube remains substantially constant from the inlet to the outlet.

6. The system of claim 1, wherein the pressure pulse dampener includes a mounting plate connected to one of the inlet or outlet ends of the tube.

7. The system of claim 6, wherein the mounting plate is connectable to a wall associated with one of the inlet and outlet chambers.

8. The system of claim 6, wherein the mounting plate is connected to an external portion of one of the inlet and outlet chambers and wherein the tube extends into one of the inlet and/or outlet chambers.

9. The system of claim 1, wherein the first portion and second portion of working fluid mix together downstream of the tube.

10. The system of claim 1, wherein the first portion and second portion of working fluid mix together within the tube.

11. A pressure pulse dampener system comprising:
an elongate axial passageway bounded by an outer wall extending between an inlet and an outlet;
a plurality of apertures extending through the outer wall;
a mounting plate extending radially outward of and connected to one end of the axial passageway;
wherein the inlet is configured to receive working fluid and the apertures are configured to transport a portion of the working fluid through the outer wall; and
wherein the working fluid transported though the elongate passageway and the portion of the working fluid transported through the outer wall merge back together downstream of the inlet of the axial passageway.

12. The pressure pulse dampener system of claim 11, wherein the axial passageway includes a non-circular cross-section.

13. The pressure pulse dampener system of claim 11, wherein a portion of the apertures are unevenly spaced from one another.

14. The pressure pulse dampener system of claim 11, wherein a portion of the apertures have substantially similar cross-sectional flow areas.

15. The pressure pulse dampener system of claim 11, wherein the cross-sectional flow area of the axial passageway varies from the inlet to the outlet along the axial direction.

16. The pressure pulse dampener system of claim 11, wherein the mounting plate is connectable to a wall associated with one of an inlet chamber and an outlet chamber of a compressor.

17. The pressure pulse dampener system of claim 11, wherein the axial passageway includes two or more separate passageways.

18. A pressure pulse dampener system comprising:
an elongate axial passageway bounded by an outer wall extending between an inlet and an outlet;
a plurality of apertures extending through the outer wall;
a mounting plate extending radially outward of and connected to one end of the axial passageway;
wherein the inlet is configured to receive a first portion of the working fluid and an external region formed about the elongate axial passageway is configured to receive a second portion of working fluid; and
wherein the apertures are configured to receive and direct the second portion of working fluid into the axial passageway to mix with the first portion of working fluid prior to exiting through the outlet.

19. The pressure pulse dampener system of claim 18, wherein the axial passageway includes a non-circular cross-section.

20. The pressure pulse dampener system of claim 18, wherein a portion of the apertures are unevenly spaced from one another.

21. The pressure pulse dampener system of claim 18, wherein a portion of the apertures have substantially similar cross-sectional flow areas.

22. The pressure pulse dampener system of claim 18, wherein the cross-sectional flow area of the axial passageway varies from the inlet to the outlet along the axial direction.

23. The pressure pulse dampener system of claim 18, wherein the mounting plate is connectable to a wall associated with one of an inlet and an outlet chamber of a compressor.

24. The pressure pulse dampener system of claim 18, wherein the axial passageway includes two or more separate passageways.

25. A method for reducing pressure pulsations in a working fluid generated by a compressor comprising:
transporting the working fluid to a pressure pulsation dampener having a central elongate section with a plurality of through apertures formed in a wall thereof, the elongate section extending between an inlet and an outlet;
directing a first portion of the working fluid through the central elongate section;
directing a second portion of the working fluid through the apertures; and
merging the first portion and second portion of working fluid back together downstream of the inlet.

26. The method of claim 25, wherein the merging occurs upstream of a compressor.

27. The method of claim 25, wherein the merging occurs downstream of a compressor.

28. The method of claim 25, wherein the merging occurs internal to the central elongate section.

29. The method of claim 25, wherein the merging occurs external to the central elongate section.

30. The method of claim 25, wherein the pressure pulsation dampener reduces audible noise levels and pressure pulsations in the working fluid.
